(19) United States
(12) Patent Application Publication
(10) Pub. No.: US 2024/0303789 A1
(43) Pub. Date: Sep. 12, 2024

(54) REFERENCE-BASED NERF INPAINTING

(71) Applicant: SAMSUNG ELECTRONICS CO., LTD., Suwon-si (KR)

(72) Inventors: Ashkan MIRZAEI, Toronto (CA); Tristan TY AUMENTADO-ARMSTRONG, Toronto (CA); Konstantinos G. DERPANIS, Toronto (CA); Igor GILITSCHENSKI, Toronto (CA); Aleksai LEVINSHTEIN, Toronto (CA); Marcus BRUBAKER, Toronto (CA)

(73) Assignee: SAMSUNG ELECTRONICS CO., LTD., Suwon-si (KR)

(21) Appl. No.: 18/389,072

(22) Filed: Nov. 13, 2023

Related U.S. Application Data
(60) Provisional application No. 63/450,739, filed on Mar. 8, 2023.

(51) Int. Cl. G06T 5/00; G06T 15/20

(52) U.S. Cl. CPC G06T 5/77; G06T 15/20

(57) ABSTRACT

Provided is a method of training a neural radiance field and producing a rendering of a 3D scene from a novel viewpoint with view-dependent effects. The neural radiance field is initially trained using a first loss associated with a plurality of unmasked regions associated with a reference image and a plurality of target images. The training may also be updated using a second loss associated with a depth estimate of a masked region in the reference image. The training may also be further updated using a third loss associated with a view-substituted image associated with a respective target image. The view-substituted image is a volume rendering from the reference viewpoint across pixels with view-substituted target colors. In some embodiments, the neural radiance field is additionally trained with a fourth loss. The fourth loss is associated with dis-occluded pixels in a target image.

### CROSS REFERENCE TO RELATED APPLICATION(S)

This application claims benefit of priority to U.S. Provisional Application No. 63/450,739 filed in the USPTO on Mar. 8, 2023. The content of the above application is hereby incorporated by reference.

### FIELD

This application is related to synthesizing a view of a 3D scene from a novel viewpoint.

### BACKGROUND

The popularity of Neural Radiance Fields (NeRFs) for view synthesis has led to a desire for NeRF editing tools.

Using existing NeRFs techniques to provide a scene representation comes with technical problems. First, the black box nature of implicit neural representations makes it infeasible to simply edit the underlying data structure based on geometric understanding. There is not explainability at the internal node level in a NeRF neural network. Second, because NeRFs are trained from images, special considerations are required for maintaining multiview consistency. Independently inpainting images of a scene using 2D inpainters yields viewpoint-inconsistent imagery. Training a standard NeRF to reconstruct these 3D inconsistent images would result in blurry inpainting.

### SUMMARY

Embodiments of the present disclosure may solve the above technical problems.

Some embodiments use a single inpainted reference, thus avoiding view inconsistencies. Also, to geometrically supervise the inpainted area, embodiments use an optimization-based formulation with monocular depth estimation. Further, embodiments obtain view dependent effects (VDEs) of non-reference views from the reference viewpoint. This enables a guided inpainting approach, propagating non-reference colors (with VDEs) into the mask area of the 3D scene represented by the NeRF. Embodiments also inpaint disoccluded appearance and geometry in a consistent manner.

Thus, embodiments are provided for inpainting regions in a view-consistent and controllable manner. In addition to the typical NeRF inputs and masks delineating the unwanted region in each view, embodiments require only a single inpainted view of the scene, i.e., a reference view. Embodiments use monocular depth estimators to back-project the inpainted view to the correct 3D positions. Then, via a novel rendering technique, a bilateral solver of embodiments constructs view-dependent effects in non-reference views, making the inpainted region appear consistent from any view. For non-reference disoccluded regions, which cannot be supervised by the single reference view, embodiments provide a method based on image inpainters to guide both the geometry and appearance. Embodiments show superior performance to NeRF inpainting baselines, with the additional advantage that a user can control the generated scene via a single inpainted image.

Provided herein is a method including receiving a plurality of images from a user, wherein the plurality of images were acquired by an electronic device viewing a first scene and each of the plurality of images is associated with a corresponding viewpoint of the first scene; receiving a first indication identifying a first image of the plurality of images, wherein the first image is associated with a first viewpoint of the first scene; receiving a second indication of a first object to be removed from the first image; removing the first object from the first image to obtain a reference image; receiving a third indication of a second viewpoint from the user, wherein the second viewpoint does not correspond to any of the plurality of images; rendering, using a neural radiance field (NeRF), a second image that corresponds to a 3D scene as seen from the second viewpoint, wherein the 3D scene has been inpainted into the NeRF; and displaying the second image on a display of the electronic device.

In some embodiments, the removing of the first object comprises performing a first inpainting on the first image by applying a mask to the first object, to obtain the reference image, wherein the method further includes: inpainting the 3D scene into the NeRF in part by adjusting a first size of the mask according to a second size of the first object that appears in the second image and applying the mask with the adjusted size to the second image; and based on a user input requesting an image of the 3D scene seen from the second viewpoint, inputting the reference image, and information of the second viewpoint to the NeRF to provide the second image corresponding to the 3D scene seen from the second viewpoint.

In some embodiments, the method also includes receiving a fourth indication from the user, wherein the fourth indication is associated with a second object to be inpainted into the first image; updating, before training the NeRF, the first image to remove the first object from the first image by using a mask, wherein the first image includes an unmasked portion and a masked portion; training the NeRF after the first object is removed from the first image.

In some embodiments, the training is performed at the electronic device.

In some embodiments, the training is performed at a server.

Some embodiments of the method also include receiving, after the displaying, a fifth indication from the user, wherein the fifth indication is a selection of a second object to be inpainted into the first image; obtaining a second representative image by inpainting the second object into the first image; updating the training of the NeRF based on the second representative image; rendering, using the NeRF, a third image; and displaying the third image on the display of the electronic device.

In some embodiments, the training the NeRF includes training the NeRF, based on the reference image and the plurality of images, using a first loss associated with the unmasked portion.

In some embodiments, the training the NeRF also includes training the NeRF using a second loss based on the masked portion and an estimated depth, wherein the estimated depth is associated with the reference view in the masked portion.

In some embodiments, the training the NeRF also includes performing a view substitution of a target image to obtain a view substituted image, wherein the view substituted image comprises view dependent effects from a third viewpoint different from the first viewpoint associated with the first image, whereby view substituted colors are obtained associated with the third viewpoint, wherein a second geometry of the first scene underlying the view substituted image is that of the reference image, wherein the plurality of images comprises the target image and the target image is not the first image; and training the NeRF using a third loss based on the view substituted colors.

In some embodiments, training the NeRF also includes identifying a plurality of disoccluded pixels, wherein the plurality of disoccluded pixels are present in the target image and are associated with the second viewpoint; determining a fourth loss, wherein the fourth loss is associated with a second inpainting of the plurality of disoccluded pixels of the target image; and training the NeRF using the fourth loss.

In some embodiments, when the first object is removed from the reference image using a first mask, and if a second size of the first object in other images differs from a first size in the reference image, adjusting proportionally mask sizes of respective masks in the other images proportionally to the respective object sizes of the first object in the other images.

Provided herein is a second method, the second method being for training a neural radiance field, the second method including initially training the neural radiance field using a first loss associated with a plurality of unmasked regions respectively associated with a reference image and a plurality of target images, wherein the reference image is associated with a reference viewpoint and each target of the plurality of target images is associated with a respective target viewpoint; updating the training of the neural radiance field using a second loss associated with a depth estimate of a masked region in the reference image; further updating the training of the neural radiance field using a third loss associated with a plurality of view-substituted images, wherein: each view-substituted image of the plurality of view-substituted images is associated with the respective target view of the plurality of target images, each view-substituted image is a volume rendering from the reference viewpoint across pixels with view-substituted target colors, and the third loss is based on the plurality of view-substituted images.

Some embodiments of the second method include additionally updating the training of the neural radiance field with a fourth loss, wherein the fourth loss is associated with dis-occluded pixels in each target image of the plurality of target images.

Also provided herein is a third method, the third method being a method of rendering an image with depth information, the third method including: receiving image data that comprises a plurality of images that show a first scene from different viewpoints; based on a first user input identifying a target object from one of the plurality of images, performing a first inpainting on the one of the plurality of images to obtain a reference image by applying a mask to the target object; inpainting a 3D scene into a neural radiance field (NeRF), based on the reference image, by adjusting a first size of the mask according to a second size of the target object in each of remaining images other than the one of the plurality of images to obtain a plurality of adjusted masks, and applying the plurality of adjusted masks to respective ones of the remaining images; and based on a second user input requesting a first image of the 3D scene seen from a requested view point, inputting the reference image, and the requested view point to a neural radiance field model to provide the first image, wherein the first image corresponds to the 3D scene seen from the requested view point.

Also provided herein is an apparatus including one or more processors; and one or more memories, the one or more memories storing instructions configured to cause the apparatus to at least: receive a plurality of images from a user, wherein the plurality of images were acquired by the apparatus viewing a first scene and each of the plurality of images is associated with a corresponding viewpoint of the first scene; receive a first indication identifying a first image of the plurality of images, wherein the first image is associated with a first viewpoint of the first scene; receive a second indication of a first object to be removed from the first image; remove the first object from the first image to obtain a reference image; receive a third indication of a second viewpoint from the user, wherein the second viewpoint does not correspond to any of the plurality of images; render, using a neural radiance field, a second image that corresponds to a 3D scene as seen from the second viewpoint, wherein the 3D scene has been inpainted into the NeRF; and display the second image on a display of the apparatus.

In some embodiments of the apparatus, the instructions are further configured to cause the apparatus to remove the first object by performing a first inpainting on the first image by applying a mask to the first object, to obtain the reference image, and wherein the wherein the instructions are further configured to cause the apparatus to: inpaint the 3D scene into the NeRF in part by adjusting a first size of the mask according to a second size of the first object that appears in the second image and applying the mask with the adjusted size to the second image; and based on a user input requesting an image of the 3D scene seen from the second viewpoint, input the reference image, and information of the second viewpoint to the NeRF to provide the second image corresponding to the 3D scene seen from the second viewpoint.

In some embodiments, the instructions are further configured to cause the apparatus to: receive a fourth indication from the user, wherein the fourth indication is associated with a second object to be inpainted into the first image; update, before a training of the NeRF, the first image to remove the first object from the first image by using a mask, wherein the first image includes an unmasked portion and a masked portion; train the NeRF after the first object is removed from the first image.

In some embodiments, the apparatus is a electronic device. In some embodiments, the electronic device is a mobile device.

In some embodiments, the instructions are further configured to cause the apparatus to: receive the NeRF from a server after a training of the NeRF, wherein the NeRF has been trained at the server.

Also provided herein is a non-transitory computer readable medium storing instructions, the instructions configured to cause a computer to at least: receive a plurality of images from a user, wherein the plurality of images were acquired by an electronic device viewing a first scene and each of the plurality of images is associated with a corresponding viewpoint of the first scene; receive a first indication identifying a first image of the plurality of images, wherein the first image is associated with a first viewpoint of the first scene; receive a second indication of a first object to be removed from the first image; remove the first object from the first image to obtain a reference image; receive a third indication of a second viewpoint from the user, wherein the second viewpoint does not correspond to any of the plurality of images; render, using a neural radiance field, a second image that corresponds to a 3D scene as seen from the second viewpoint, wherein the 3D scene has been inpainted into the NeRF; and display the second image on a display of the electronic device.

### BRIEF DESCRIPTION OF THE DRAWINGS

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of embodiments provided herein.

FIG. 1A illustrates logic for rendering an inpainted 3D scene from a novel viewpoint, according to some embodiments.

FIG. 1B illustrates adding a selected object to a 3D scene, according to some embodiments.

FIG. 1C illustrates a rendering of the inpainted 3D scene of FIG. 1B from the novel viewpoint, according to some embodiments.

FIG. 2A illustrates system for providing the novel view, according to some embodiments.

FIG. 2B illustrates logic for training a NeRF to represent an inpainted 3D scene and using the NeRF to obtain the novel view, according to some embodiments.

FIG. 3 illustrates training the NeRF to represent an inpainted 3D scene, according to some embodiments.

FIG. 4 illustrates further details of training the NeRF of FIG. 3 to represent the inpainted 3D scene, according to some embodiments.

FIG. 5 illustrates geometry related to a view substitution technique.

FIG. 6 represents an input image.

FIG. 7 illustrates removing a backpack from the input image of FIG. 6 and receiving a text command to inpaint a red fence, and inpainting the red fence.

FIG. 8 illustrates removing a backpack from the input image of FIG. 6 and receiving a text command to inpaint a rubber duck, and inpainting the rubber duck.

FIG. 9 illustrates removing a backpack from the input image of FIG. 6 and receiving a text command to inpaint a flower pot, and inpainting the flower pot.

FIG. 10 illustrates an input image with a backpack as an object to be removed.

FIG. 11 illustrates the red fence replacing the backpack using 2D inpainting.

FIG. 12, related to FIG. 10, illustrates replacing the backpack by pasting an image of a mailbox.

FIG. 13, related to FIG. 10, illustrates replacing the backpack by inpainting the red fence and then manually pasting a shrub.

FIG. 14 illustrates a reference image in which an object has been removed.

FIG. 15 illustrates a set of input images.

FIG. 16 illustrates a set of masks corresponding to the input images of FIG. 15.

FIG. 17 illustrates an initial target view with distortion in the area corresponding to the inpainting in the reference view.

FIG. 18 illustrates a residual with respect to the target view of FIG. 17.

FIG. 19 illustrates an updated rendering of the target view based on the residual of FIG. 18.

FIG. 20 illustrates Disocclusion processing to improve the inpainted 3D scene represented by the NeRF for views other than the reference view.

FIG. 21 illustrates exemplary hardware for implementation of computing devices for implementing the systems and algorithms described by the figures, according to some embodiments.

### DETAILED DESCRIPTION

The present disclosure provides methods and apparatuses for inpainting an unwanted object in one of several 2D images forming a complete 3D scene representation. The unwanted object is removed from any viewpoint within the 3D scene image.

In particular, NeRF techniques may be used to inpaint unwanted regions in a view-consistent manner, allowing users to exercise control over the generated scene through a single inpainted image.

NeRFs are an implicit neural field representation (i.e., coordinate mapping) for 3D scenes and objects, generally fit to multiview posed image sets. The basic constituents are (i) a field, f_{θ}:(x,d)→(c,σ), that maps a 3D coordinate, x∈R³, and a view direction, d∈S², to a color, c∈R³, and density, σ∈R⁺, via learnable parameters θ, and (ii) a rendering operator that produces color and depth for a given view pixel. The field, f_{θ}, can be constructed in a variety of ways; the rendering operator is implemented as the classical volume rendering integral, approximated via quadrature, where a ray, r, is divided into N sections between tₙ and t_{f} (the near and far bounds), with tᵢ sampled from the i-th section. The estimated color is then given by Equation 1.

$$\hat{C} ( r ) = {\sum }_{i = 1}^{N} {T}_{i} ( 1 - exp ( - {σ}_{i} {δ}_{i} ) ) {c}_{i} \qquad Equation 1$$

where Tᵢ is the transmittance, δᵢ=tᵢ₊₁−tᵢ and cᵢ and σᵢ are the color and density at tᵢ. Replacing cᵢ with tᵢ in Equation 1 estimates depth, \hat{ζ}(r), and disparity (inverse depth,) \hat{D}(r)= [symbol] (r), instead.

The inputs are n input images, {Iᵢ}ᵢ₌₁^{K}, their camera transform matrices, {Πᵢ}ᵢ₌₁^{K}, and their corresponding masks, {Mᵢ}ᵢ₌₁^{K}, delineating the unwanted region. The inputs also include a single inpainted reference view, I_{ref}, where ref∈{1, 2, . . . , K}, which provides the information which embodiments map, or extrapolate, into a 3D inpainting of the scene represented by the NeRF.

Embodiments use I_{ref}, not only to inpaint the NeRF, but also to generate 3D details and VDEs from other viewpoints.

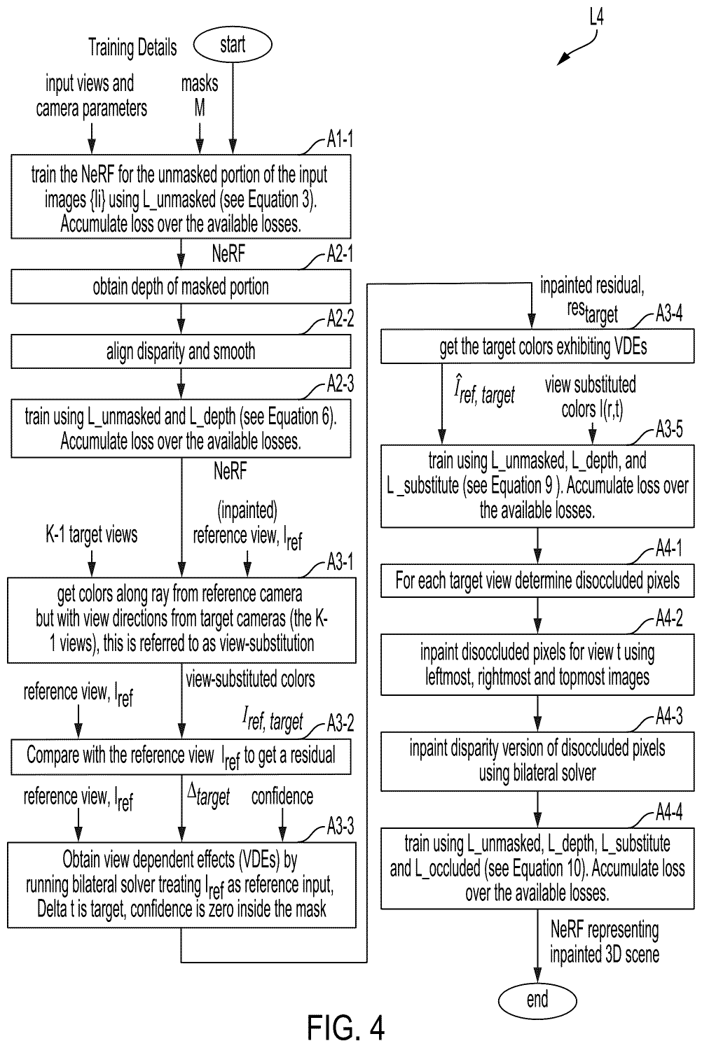

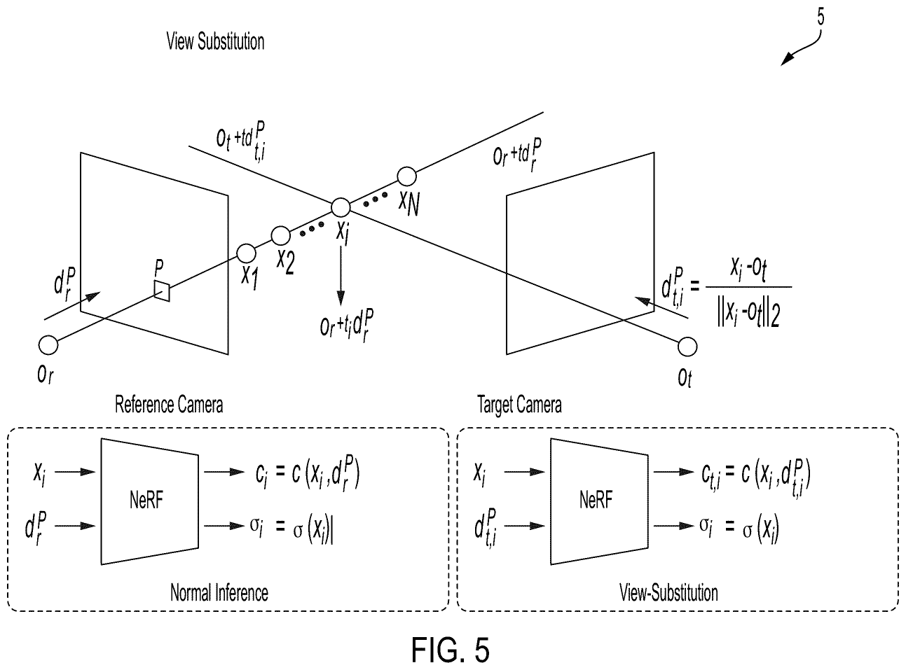

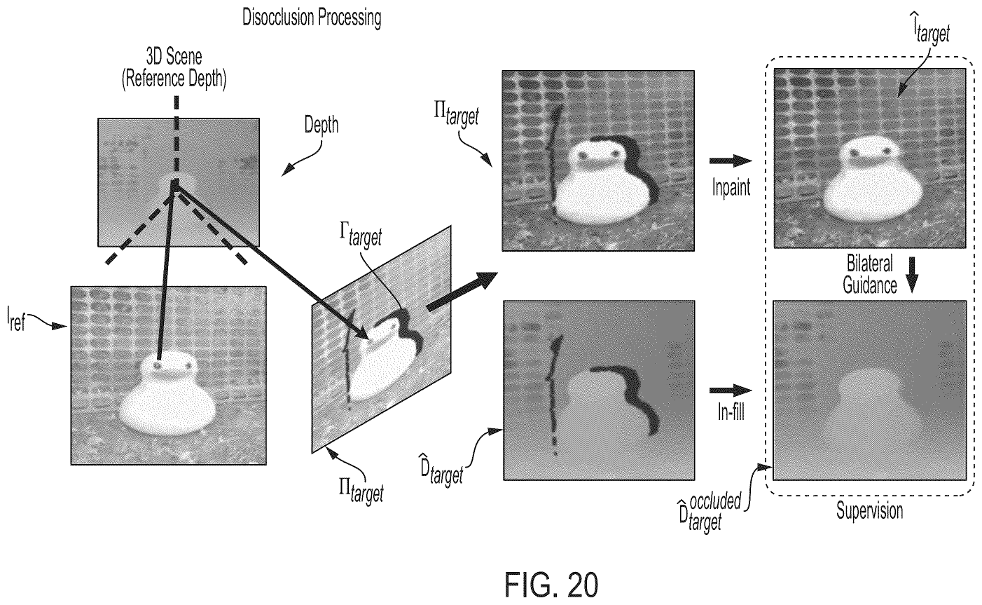

Below, the following topics are discussed: i) the use of monocular depth estimators to guide the geometry of the inpainted region, according to the depth of the reference image, I_{ref} (see FIG. 4 items A2-1, A2-2 and A2-3), ii) the use of bilateral solvers, in conjunction with a view-substitution technique of embodiments, to add VDEs to views other than the reference view (see FIG. 5 and FIGS. 14-19 for a depiction of the geometry supervision and VDE handling, and iii) since not all the masked target pixels are visible in the reference, embodiments provide supervision during training for such dis-occluded pixels, via additional inpaintings (see FIG. 20).

In general, training includes an experience with respect to a task and attempts to improve a performance with respect to performance of the task at a future time after the training.

In some embodiments, training is based on the following four losses: i) L_unmasked, ii) L_depth, iii) L_substituted and iv) L_occluded. These four losses represent the unmasked appearance loss, masked geometry loss, view-dependent masked color loss, and dis-occlusion loss, respectively.

The overall objective for inpainted NeRF fitting is given by Equation 2 (including weights y on the last three terms).

$$L = L\_unmasked + {γ}_{depth} L\_depth + {γ}_{sub} L\_substituted + {γ}_{occluded} L\_occluded \qquad Equation 2$$

Supervision is computed modulo an iteration count. For example, supervision for the respective summands of Equation 2 are computed every N_{unmasked}, N_{depth}, N_{sub} and N_{occluded} iterations. A particular loss is not used until the appropriate number of iterations has passed.

In the first stage of training, f_{θ} is supervised on the unmasked pixels for N_{unmasked} iterations, via a NeRF reconstruction loss shown in Equation 3.

$$L\_unmasked = {E}_{r ∼ {R}_{unmasked}} {‖ \hat{C} ( r ) - {C}_{GT} ( r ) ‖}^{2} \qquad Equation 3$$

In Equation 3, R_{unmasked} (in contrast to R_{masked}) is the set of rays corresponding to the pixels in the unmasked part of the image (the part not affected by the mask) and C_{GT}(r) is the ground truth (GT) color for the ray, r.

The loss for the masked portion based on depth is developed by Equations 4, 5 and 6.

$${D}_{γ} = {a}_{0} {\tilde{D}}_{r} + {a}_{1} {J}_{hw} + {a}_{2} H + {a}_{3} V \qquad Equation 4$$

$${F}_{wf} ( \{ {a}_{i} \} ) = {\sum }_{p ∈ {I}_{r} ⊙ ( 1 - {M}_{r} )} {w ( p ) [ {D}_{r} ( p ) - ( p ) ]}^{2} \qquad Equation 5$$

$$L\_depth = {E [ ( {r}^{′} ) - {D}_{r}^{smooth} ( {r}^{′} ) ]}^{2} \qquad Equation 6$$

Above, scalars h and w are the height and width of the input images.

Concerning the matrices H and V, for a pixel p at position (pₓ,p_{y}), H(p)=pₓ and V=p_{y}.

The monocular depth estimation of the masked region from the reference image, in terms of disparity, is [symbol] . The disparity from the NeRF model is [symbol] .

The coefficients a₀, a₁, a₂, a₃ in Equation 4 are found by optimization, with F being the objective (Equation 5).

In Equation 4, J is the all-ones matrix.

The inverse of the distance between p and the mask is w(p).

In Equation 6, the expectation is over r′∈R_{masked}.

Also in Equation 6, Dᵣ^{smooth} is a variable obtained by optimizing Dᵣ to encourage greater smoothness around the mask. An example smoothing technique minimizes the total variation of Dᵣ around mask boundaries.

A loss to obtain VDEs for the masked portion is developed by Equations 7, 8 and 9.

$${d}_{t , i}^{p} = ( {x}_{i} - {o}_{t} ) / {‖ {x}_{i} - {o}_{t} ‖}^{2} \qquad Equation 7$$

$${res}_{t} = B ( {I}_{r} , {I}_{r} - {I}_{r , t} , ( 1 - {M}_{r} ) \times {c}_{max} ) \qquad Equation 8$$

$$L\_substituted = \frac{1}{K} {\sum }_{t = 1}^{K} E {‖ {I}_{r , t} ( {r}^{′} ) - {\hat{I}}_{r , t} ( {r}^{′} ) ‖}^{2} \qquad Equation 9$$

The expectation in Equation 9 is over r′˜R_{masked}^{r}.

A loss to solve for occluded areas in the reference image which are however visible in a non-reference image is provided by Equation 10.

$$L\_occluded = E [ {‖ \hat{C} ( r ) - {C}_{t} ( r ) ‖}^{2} + ϵ ( r ) ] \qquad Equation 10$$

In Equation 10, the expectation is over (t˜T, r˜R_{do,t}), ∈(r)=η_{do}[\hat{D}(r)−Dₜ(r)]², η_{do}>0, and color and disparity are Cₜ(r)=Îₜ^{o}[r] and Dₜ(r)=\hat{D}ₜ^{o}[r].

The above equations are discussed with reference to the drawings. Before discussing the drawings, a partial list of identifiers with comments is provided here.

L_unmasked: this is a NeRF reconstruction loss over the unmasked area of the K input images. See Equation 3.

L_depth: this loss is based on monocular depth estimation \tilde{D}(⋅) to predict an uncalibrated disparity of the reference image and guide the geometry. See Equation 6.

L_substituted: this loss accounts for view-dependent effects (VDEs) such as specularities and surfaces which are not rough (do not deflect light in every direction). See Equation 9.

L_occluded: the overall algorithm is focused on the reference view, and pixels which are visible in target views but not visible in the reference view are called dis-occluded pixels (they are occluded in the reference view, and become dis-occluded when the scene is viewed from other viewpoints). This loss supervises the NeRF training so that the NeRF produces plausible results with respect to these dis-occluded pixels. See Equation 10.

Iᵢₙ: the input image chosen as the basis for the reference image.

I_{target}: the set of input images, excluding Iᵢₙ.

I_{ref}: the reference image, constructed by inpainting a portion of Iᵢₙ.

Iₙₒᵥₑₗ: an image of the 3D scene inpainted into the NeRF; Iₙₒᵥₑₗ is from a user-requested viewpoint, and Iₙₒᵥₑₗ is produced by the NeRF.

I_{ref,target}: a view-substituted image produced by the NeRF and associated with one of the target viewpoints.

Î_{ref,target}: the view-substituted image with VDEs from res_{target} after using Equation 8.

Γ_{target}: confidences used by a bilateral solver in dis-occlusion processing.

Π_{target}: a target view, exhibiting dis-occluded pixels.

\hat{D}_{target}: a disparity image produced by the NeRF during dis-occlusion processing.

Î_{target}: an inpainted version of the target view exhibiting dis-occluded pixels.

\hat{D}_{target}^{occluded}: a disparity image obtained using bilateral guidance applied to Î_{target}.

Δ_{target}=I_{ref}−I_{ref,target}: a residual used in obtaining the VDEs for one of the target viewpoints.

Obtaining the novel view from the 3D inpainted into the NeRF is now described with respect to the figures.

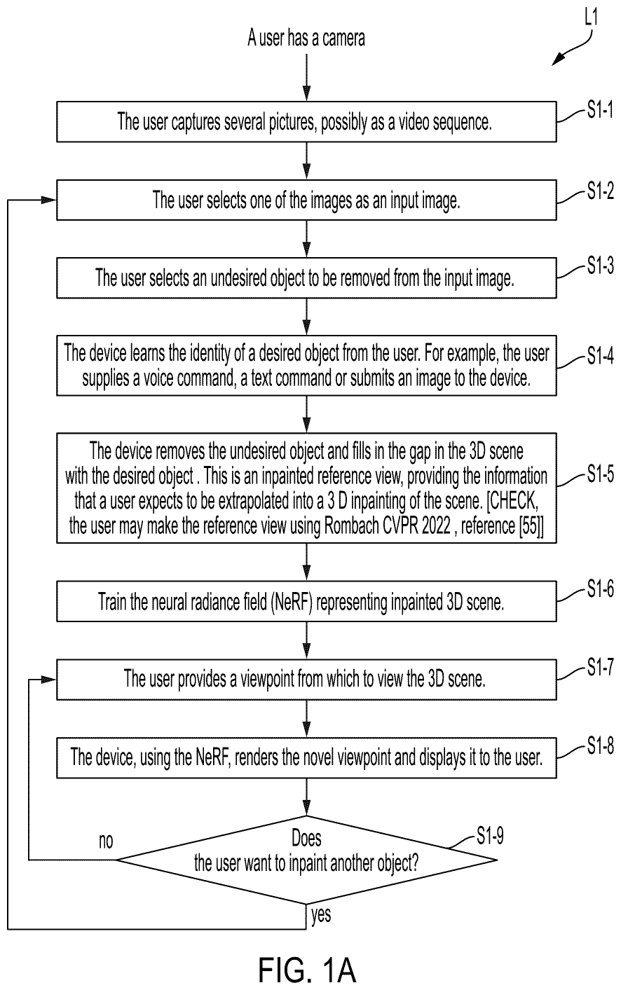

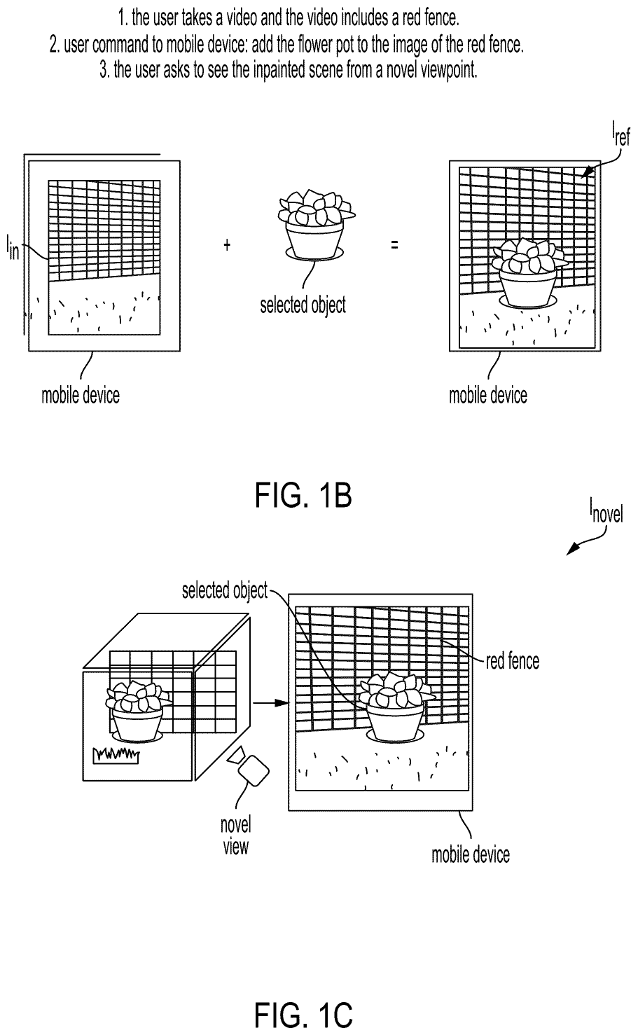

FIG. 1A illustrates logic L1 for rendering an inpainted 3D scene from a novel viewpoint.

For example, a user has a camera. At operation S1-1, the user captures several pictures, possibly as a video sequence.

At operation S1-2, the user selects one of the images as an input image.

At operation S1-3, an undesired object is selected to be removed from the input image.

In some embodiments, the electronic device performs the selection by recommending objects to be erased by the device. The electronic device may select portions of the images with many light reflections, blurry portions, or portions identified by the electronic device as background objects.

In some embodiments, the user performs the selection. The user selects an area around an object, the electronic device analyzes the identified area and electronic device selects around the object outline.

Some embodiments include an additional selection by the electronic device based on user-selected information. In these embodiments, the electronic device analyzes the selected object and recommends whether other objects of a similar type to the object selected by the user should also be selected and erased from the images.

The undesired object is removed from the images using masks.

Generally, at operation S1-4, a device receives information about the object to be inpainted into an image from the user. The device is an electronic device. The receiving method may be by text or by voice, and the image corresponding to a text and the image corresponding to voice are shown, and those images can be inserted into the desired input location. As one example, the device used by the user (possibly a mobile terminal which includes the camera), determines the identity of a desired object from the user. The identification may be by voice command, text command or from an image submitted to the device. The desired object is inpainted to a reference image. As another example, the user has the option, in some embodiments, to communicate the new object not only by text or voice, but to provide an image of the desired object, for example to perform manual insertion of an image. The inserted image, in some embodiments is downloaded from the Internet (something the user found appealing), or the inserted image is from the user's photo gallery or another photo gallery.

In some embodiments, there are multiple images corresponding to the text when a user enters text. Embodiments are configured to allow a user to select from the multiple images indicated in a list shown at the bottom of the electronic device user interface display or on the side of the electronic device user interface display. Embodiments also allow a user to move the image part as desired once the image that corresponds to the multiple texts is selected, and that image part enters the inpainted region.

At operation S1-5, the device, using the NeRF, removes the undesired object and fills in the gap in the 3D scene with the desired object, this creates I_{ref}. Methods for performing this inpainting are known to practitioners working in this field. I_{ref} is an inpainted reference view, providing the information that a user expects to be extrapolated into a 3D inpainting of the scene which is the subject of the images {Iᵢ}.

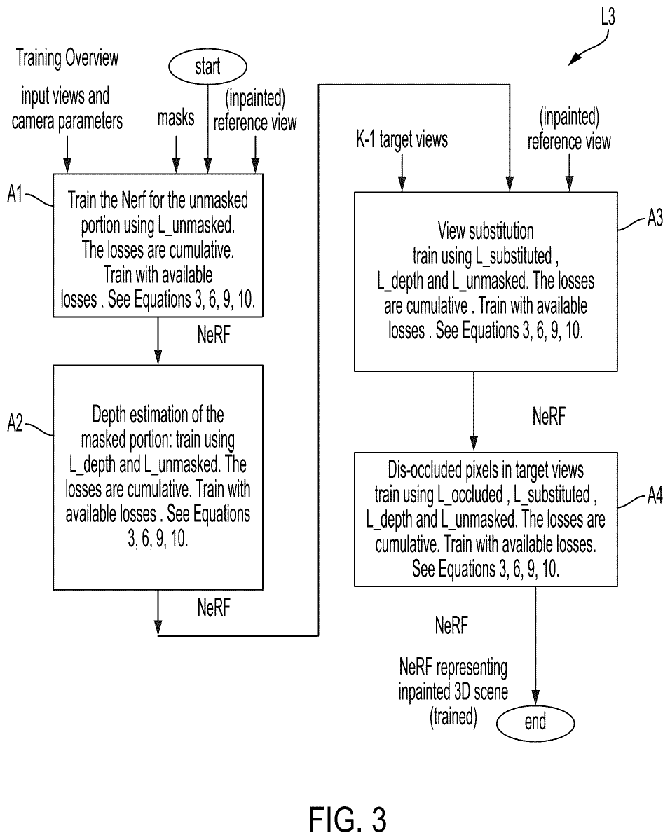

At operation S1-6, a neural radiance field (NeRF) is trained to represent the inpainted 3D scene. See FIGS. 3-4 and Equations 1-10.

At operation S1-7, the user provides a viewpoint from which to view the 3D scene.

At operation S1-8, the device renders the novel viewpoint and displays it to the user. See FIG. 1C.

At operation S1-9, the user may choose to inpaint another object or to view the 3D scene from yet another viewpoint.

FIG. 1B illustrates adding a selected object to a 3D scene, according to some embodiments.

FIG. 1B illustrates a mobile device displaying a first image Iᵢₙ. A mobile device is an example and embodiments are not limited to mobile devices. In general, embodiments are applicable to electronic devices. The user selects an object (a flowerpot in FIG. 1B) and adds it to the first image Iᵢₙ to obtain an inpainted version of the first image, reference image I_{ref}.

FIG. 1C illustrates a rendering of the inpainted 3D scene of FIG. 1B from the novel viewpoint of obtain the image Iₙₒᵥₑₗ.

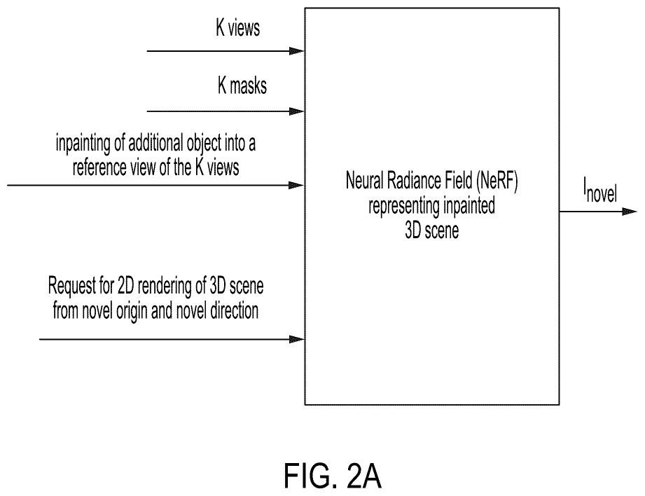

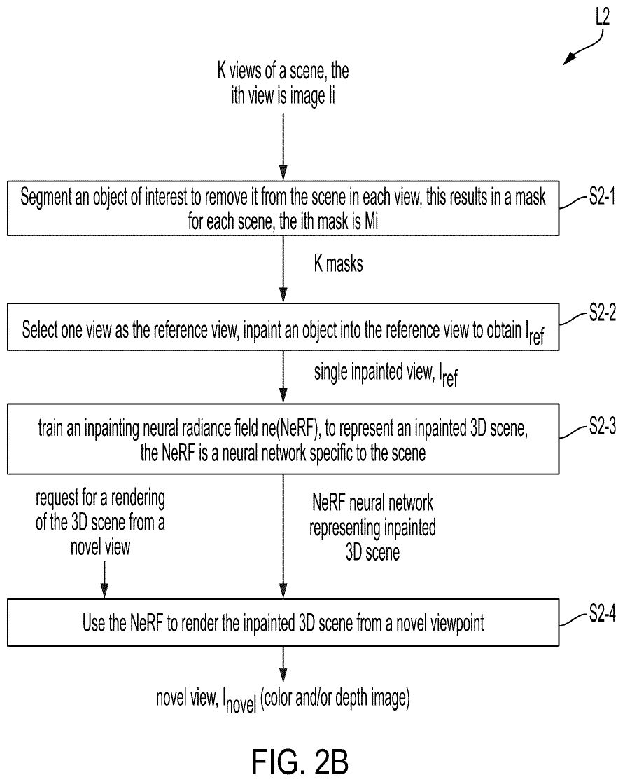

FIG. 2A illustrates the overall system for providing the novel view. K views, K masks, the reference view with an additional object inpainted, and a request for a rendering from a novel viewpoint are provided to the NeRF. The training of the NeRF may occur at a mobile terminal or at a server. The NeRF provides a novel view of an inpainted 3D scene.

FIG. 2B illustrates logic L2 for training a NeRF to represent an inpainted 3D scene and using the NeRF to obtain the novel view Iₙₒᵥₑₗ.

At operation S2-1, an undesired object is segmented to remove it from the scene in each view. This results in a mask for each scene. The i^{th} mask is denoted Mᵢ.

At operation S2-2, one of the images from the set {Iᵢ} is selected as the input image from which to create the reference image I_{ref}. At operation S2-3, an inpainting neural radiance field is trained to represent an inpainted 3D scene. The NeRF is a neural network specific to the scene.

At operation S2-4, the NeRF is used to render the inpainted 3D scene from a novel viewpoint, to obtain Iₙₒᵥₑₗ.

FIG. 3 illustrates logic L3 for training the NeRF to represent an inpainted 3D scene in terms of four training epochs.

Each training phase in the figure has a predefined number of iterations inside it. Each training iteration in NeRF training samples random rays from the input views in the scene, renders them using the current NeRF network, and updates the NeRF parameters by minimizing the corresponding losses.

The loss L_unmasked is used at operation A1. See Equation 3. Operation A1 is performed once every N_{unmasked} iterations. The losses L_depth and L_unmasked are used at operation A2. See Equations 3 and 6. Operation A2 is performed once every N_{depth} iterations. The losses L_substituted, L_depth and L_unmasked are used at operation A3. See Equations 3, 6 and 9. Operation A3 is performed once every N_{substituted} iterations. The losses L_occluded, L_substituted, L_depth and L_unmasked are used at operation A4. See Equations 3, 6, 9 and 10. Operation A4, is performed once every N_{occluded} iterations.

In some embodiments, one or more of A2, A3 and A4 is not used at all in training the NeRF.

FIG. 4 illustrates further details of training the NeRF of FIG. 3 to represent the inpainted 3D scene.

At operation A1-1, the NeRF is trained for the unmasked portion of the images {Iᵢ}.

At operation A2-1, depth is obtained of the masked portion in the reference image. At A2-2 disparity alignment and smoothing is performed. At operation A2-3, training is performed using L_unmasked and L_depth.

At A3-1, colors along a ray from the reference camera are obtained but with view directions from target cameras. This is referred to as view-substitution. At operation A3-2 a comparison is made with the reference view to get a residual, Δ_{target}. At operation A3-3, view dependent effects are obtained by using a bilateral solver. See Equation 8. At A3-4, target colors are which include the VDEs for this view. At operation A3-5, training is performed using L_unmasked, L_depth and L_substituted.

At A4-1, disoccluded pixels are determined by reprojecting all pixels from the reference view into a target view. At A4-2, the disoccluded pixels are inpainted using leftmost, rightmost and topmost target images. At A4-3, a disparity version of the dis-occluded pixels is inpainted using a bilateral solver. At A4-4, training of the NeRF is performed using L_unmasked, L_depth, L_substituted, and L_occluded. See Equations 3, 6, 9, 10.

FIG. 5 illustrates geometry related to a view substitution technique. The view substitution technique disclosed herein enables rendering from the reference viewpoint, but with the view-dependent effects of a target viewpoint, by substituting the directional input to the per-shading-point neural color field. The upper portion of FIG. 5 illustrates that, given a shading point position, xᵢ, on a ray emanating from the reference camera (with direction dᵣ^{p}), embodiments obtain the corresponding ray direction, d_{t,i}^{p}, that intersects xᵢ from a target-image camera (at oₜ). The lower portion of FIG. 5 illustrates, on the left, that standard inputs are used to query the NeRF for the colour, c(xᵢ, dᵣ^{p}), at shading point xᵢ. The lower right portion of FIG. 5 shows that view-substituted inputs are used to query the NeRF, obtaining c(xᵢ, d_{t,i}^{p}) as the color instead.

The NeRF (for example, in FIG. 5) provides 3D information (3D point color and density), which then have to be integrated along a ray to get rendered (i.e. get a view). The output from a NeRF network is 3D.

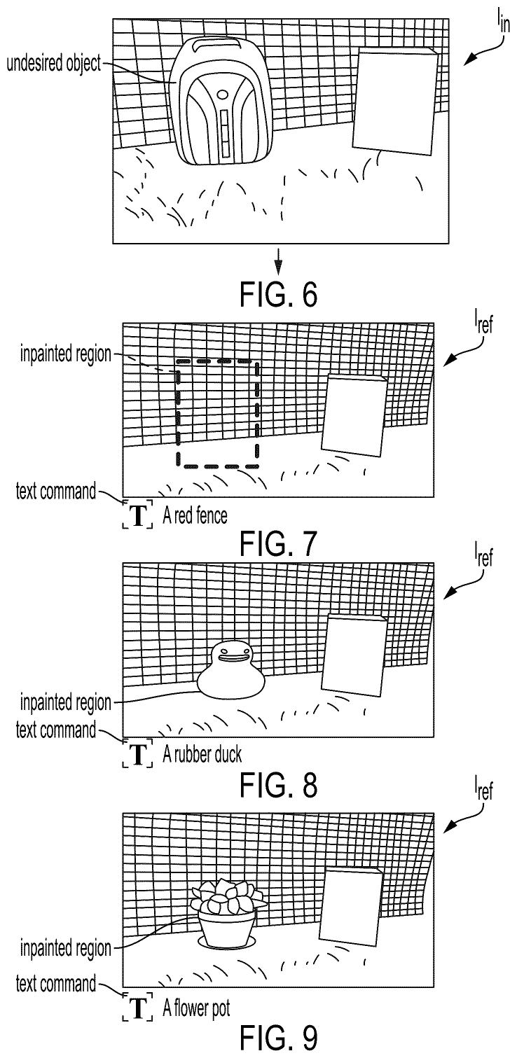

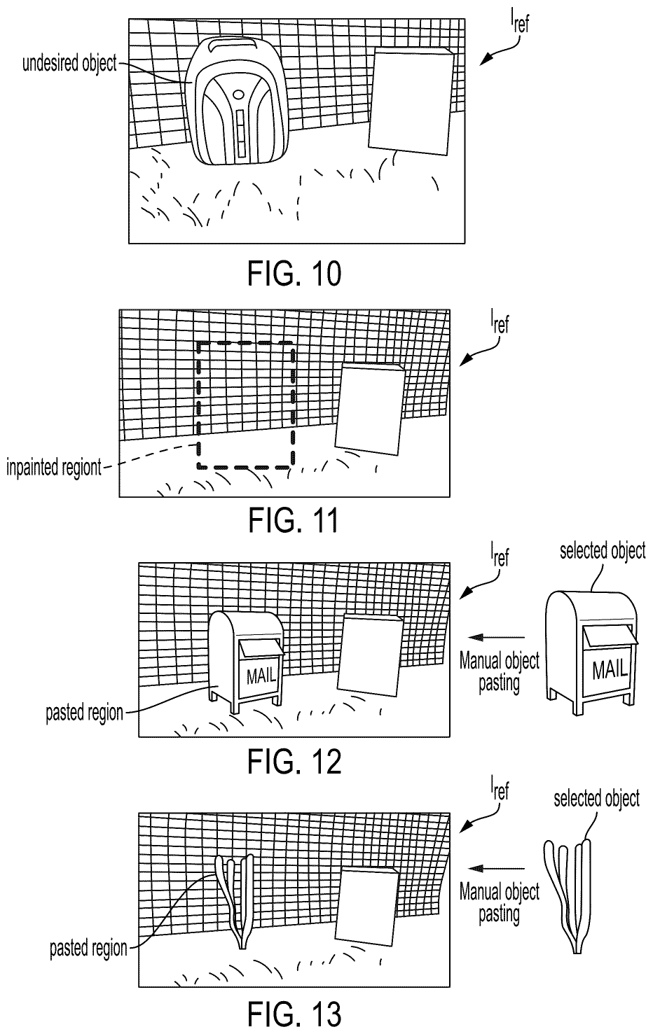

FIGS. 6-11 present some example results at the level of image changes. FIG. 6 represents an input image, Iᵢₙ. FIG. 7 illustrates removing a backpack from the input image of FIG. 6 and receiving a text command to inpaint a red fence, and inpainting the red fence. FIG. 8 illustrates removing a backpack from the input image of FIG. 6 and receiving a text command to inpaint a rubber duck, and inpainting the rubber duck. FIG. 9 illustrates removing a backpack from the input image of FIG. 6 and receiving a text command to inpaint a flower pot, and inpainting the flower pot. FIG. 10 illustrates an input image with a backpack as an undesired object to be removed. FIG. 11 illustrates the red fence replacing, in an inpainted region, the backpack using 2D inpainting.

Generally, a user may capture a plurality of images or a short video, while moving a camera around a scene. The user may then interactively segment the object of interest from the scene, using well known techniques.

In embodiments, reference-guided controllable 3D scene inpainting is performed. A user selects a view and uses a controllable 2D inpainting method to inpaint the object. The controllable inpainting method is, for one example, stable diffusion inpainting guided by text input. Alternatively, the user creates the inpainted image by first inpainting it with the background using any 2D inpainting method and then overlays an object of interest manually in the inpainted region. An inpainting NeRF is then trained guided by the single inpainted view. The inpainted NeRF is used to render the inpainted 3D scene from arbitrary views.

For example, FIG. 12, related to FIG. 10, illustrates replacing the backpack by pasting an image of a mailbox. FIG. 13, related to FIG. 10, illustrates replacing the backpack by inpainting the red fence and then manually pasting a shrub.

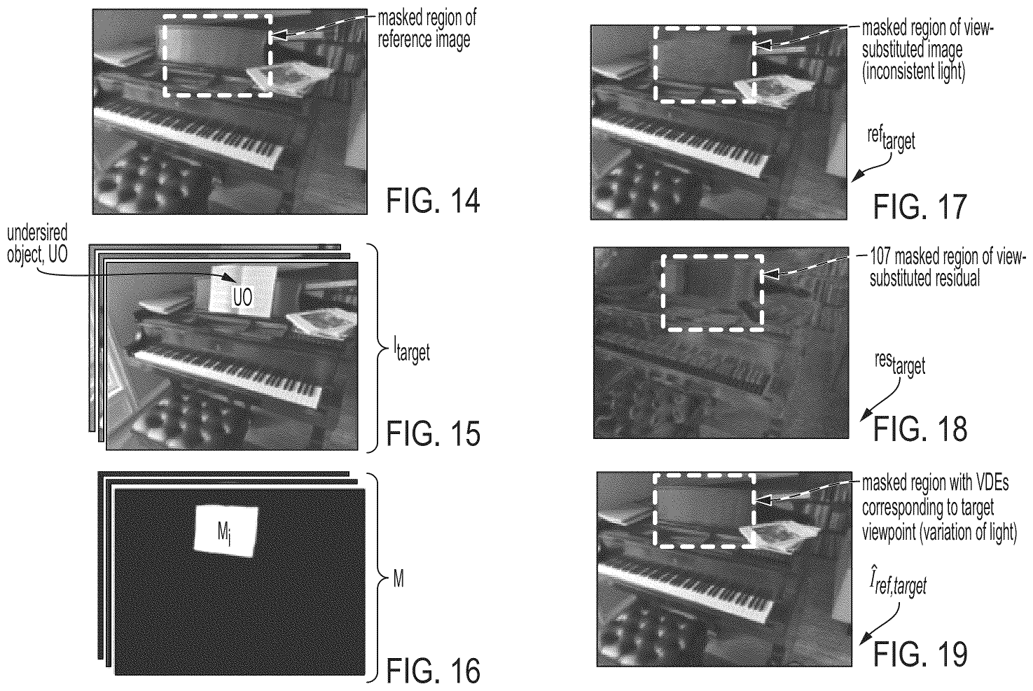

FIG. 14 illustrates a reference image, I_{ref}, in which an object has been removed. FIG. 15 illustrates a set of input images. The images of {Iᵢ} other than Iᵢₙ are referred to as target images. The undesired object, UO, in FIG. 15 is a music book on a piano stand. FIG. 16 illustrates a set of masks Mᵢ corresponding to the input images of FIG. 15. FIG. 17 illustrates an initial target view, I_{ref,target} with distortion in the area corresponding to the inpainting in the reference view. FIG. 18 illustrates a residual, res_{target} with respect to the target view of FIG. 17. FIG. 19 illustrates an updated rendering, Î_{(ref,target)}, of the target view based on the residual of FIG. 18.

Embodiments provide view-dependent effects as follows. For each target, t, the scene is rendered from the reference camera with target colors to get the view-substituted image, I_{ref,target} (FIG. 17). A bilateral solver inpaints the residual between the reference view and the view-substituted image, see Equation 8, resulting in the inpainted residual, res_{target} (FIG. 18), which is subtracted from the reference view to get the target color, Î_{(ref,target)} (FIG. 19). The discrepancy between the target colors and the view-substituted images provides supervision for the masked region.

After obtaining the view substituted images {Î_{ref,j}}ⱼ₌₁^{K} (after at least N_{substituted} iterations), the training is able to supervise the masked appearances of the target images. Each such image Î_{ref,target} looks at the scene via the reference source camera (i.e., has the image structure of I_{ref}), but has the colors (in particular, VDEs) of I_{target}. Embodiments use those colors, obtained by the bilateral solver of Equation 8, to supervise the target view appearance under the mask (that is, in Rₘₐₛₖ). Embodiments render each view-substituted image inside the mask (obtaining I_{ref,target} as in FIG. 17 as in § 4.2.1), and compute a reconstruction loss by comparing it to the bilaterally inpainted output, Î_{ref,target} as shown in Equation 9.

FIG. 20 illustrates dis-occlusion processing to improve the inpainted 3D scene represented by the NeRF for views other than the reference view.

While single-reference inpainting prevents problems incurred by view-inconsistent inpaintings, it is missing multiview information in the inpainted region. For example, when inserting a duck into the scene (see FIG. 20), viewing the scene from another perspective naturally unveils new details on and around the duck, due to dis-occlusions (see the dark areas marked as Γ_{target} in the image second from left in FIG. 20). Embodiments construct these missing details.

Embodiments identify pixels in the target view, Π_{target} (also referred to as I_{target}), that are not visible from the reference view, to build a dis-occlusion mask, Γ_{target}. From Π_{target}, embodiments then inpaint a Γ_{target}-masked color, see the upper right image in FIG. 20. This is followed by in-filling a disparity rendered image, using bilateral guidance to ensure consistency. See the upper right image in FIG. 20 (Î_{target}) and the disparity image \hat{D}_{target}^{occluded} of FIG. 20 which are arguments for terms in L_occluded of Equation 10. Finally, these inpainted disoccluded values are used for supervision. See A4 of FIG. 3.

Quantitative full-reference (FR) evaluation of 3D inpainting techniques on the inpainted areas of held-out views from the SPIn-NeRF dataset are shown in Table 1. Columns show distance from known ground-truth images of the scene (without the target object), based on a perceptual metric (LPIPS) and feature-based statistical distance (FID).

Embodiments with stable diffusion (SD) perform best by both metrics.

TABLE 1

| Method | LPIPS | FID |
|---|---|---|
| NeRF + LaMa (2D) [ | 0.5369 | 174.61 |
| Object NeRF | 0.6829 | 271.80 |
| L_unmasked | 0.6030 | 294.69 |
| L_unmasked + DreamFusion | 0.5934 | 264.71 |
| NeRF-In, multiple | 0.5699 | 238.33 |
| NeRF-In, single | 0.4884 | 183.23 |
| SPIn-NeRF-SD | 0.5701 | 186.48 |
| SPIn-NeRF-LaMa | 0.4654 | 156.64 |
| Embodiments (FIGS. 3-4 | 0.4532 | 116.24 |
| and Equations 1-10), | | |
| using stable diffusion | | |

As seen in Table 1, embodiments provide the best performance on both FR metrics. The Object-NeRF and Masked-NeRF approaches, which perform object removal without altering the newly revealed areas, perform the worst. Combining Masked-NeRF with DreamFusion performs slightly better. This indicates some utility of the diffusion prior; however, while DreamFusion can generate impressive 3D entities in isolation, it does not produce sufficiently realistic outputs for inpainting real scenes. SPIn-NeRF-SD obtains a similar poor LPIPS, though with better FID. It is unable to cope with the greater mismatches of the SD generations. NeRF-In outperforms the aforementioned models. Still, the use of a pixelwise loss leads to blurry outputs. Finally, our model outperforms the second-best model (SPIn-NeRF-LaMa) considerably in terms of FID, reducing it by ˜25%.

Embodiments are also applicable to videos. Table 2 provides an indication of the technical improvement. SD and LaMa are known inpainters.

TABLE 2

| Method | Sharpness | MUSIQ |
|---|---|---|
| SPIn-NeRF-LaMa | 354.31 | 58.10 |
| Embodiments, using LaMa | 394.55 | 62.0 |
| Embodiments, using SD | 398.56 | 61.47 |

FR measures are limited by their use of a single GT target image. We therefore also examine NR performance, demonstrating improvements over SPIn-NeRF, in terms of both sharpness (by 11.2%) and MUSIQ (by 5.8%); see Table 2. Table 2 indicates that embodiments provide a novel view which is numerically more sharp and more realistic.

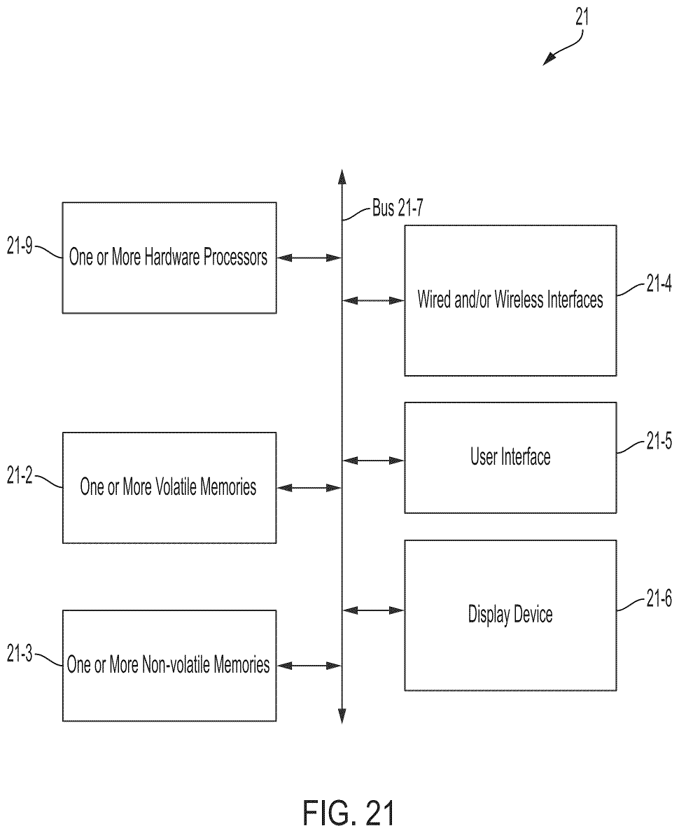

Hardware for performing embodiments provided herein is now described with respect to FIG. 21. FIG. 21 illustrates an exemplary apparatus 21-1 for implementation of the embodiments disclosed herein. The apparatus 21-1 may be a server, a computer, a laptop computer, a handheld device, or a tablet computer device, for example.

As a first example, the an NeRF of FIG. 2A performing the logic L2 of FIG. 2B is located on the electronic device, and the logic L2 processes the received information from an input unit of the electronic device.

As a second example, the NeRF of FIG. 2A performing the logic L2 of FIG. 2B is located on a server, and the images are server images. An input value of the server image (area select, receiving object information to be inpainted, content received from text/voice) is received from the communication unit of the server and applied using the logic L2 of FIG. 2B.

Apparatus 21-1 may include one or more hardware processors 21-9. The one or more hardware processors 21-9 may include an ASIC (application specific integrated circuit), CPU (for example CISC or RISC device), and/or custom hardware. Embodiments can be deployed on various GPUs. As an example, a provider of GPUs is Nvidia™, Santa Clara, California. For example, embodiments have been deployed on Nvidia™ A6000 GPUs with 48 GB of GDDR6 memory.

Embodiments may be deployed on various computers, servers or workstations. Lambda™ is a workstation company in San Francisco, California. Experiments using embodiments have been conducted on a Lambda™ Vector Workstation.

Apparatus 21-1 also may include a user interface 21-5 (for example a display screen and/or keyboard and/or pointing device such as a mouse). Apparatus 21-1 may include one or more volatile memories 21-2 and one or more non-volatile memories 21-3. The one or more non-volatile memories 21-3 may include a non-transitory computer readable medium storing instructions for execution by the one or more hardware processors 21-9 to cause apparatus 21-1 to perform any of the methods of embodiments disclosed herein.

Embodiments provide an approach to inpaint NeRFs, via a single inpainted reference image. Embodiments use a monocular depth estimator, aligning its output to the coordinate system of the inpainted NeRF to back-project the inpainted material from the reference view into 3D space. Embodiments also use bilateral solvers to add VDEs to the inpainted region, and use 2D inpainters to fill dis-occluded areas. Table 1 and Table 2, using multiple evaluation metrics, illustrate the superiority of embodiments over prior 3D inpainting methods.

Finally, embodiments include a controllability advantage enabling users to easily alter a generated 3D scene through a single guidance image (I_{ref}).

What is claimed is:

1. A method comprising:
receiving a plurality of images from a user, wherein the plurality of images were acquired by an electronic device viewing a first scene and each of the plurality of images is associated with a corresponding viewpoint of the first scene;
receiving a first indication identifying a first image of the plurality of images, wherein the first image is associated with a first viewpoint of the first scene;
receiving a second indication of a first object to be removed from the first image;
removing the first object from the first image to obtain a reference image;
receiving a third indication of a second viewpoint from the user, wherein the second viewpoint is different from each of the respective viewpoints of the plurality of images;
rendering, using a neural radiance field (NeRF), a second image that corresponds to a 3D scene as seen from the second viewpoint, wherein the 3D scene has been inpainted into the NeRF; and
displaying the second image on a display of the electronic device.

2. The method of claim 1, wherein the removing of the first object comprises performing a first inpainting on the first image by applying a mask to the first object, to obtain the reference image, wherein the method further comprises:
inpainting the 3D scene into the NeRF in part by adjusting a first size of the mask according to a second size of the first object that appears in the second image and applying the mask with the adjusted size to the second image; and
based on a user input requesting an image of the 3D scene seen from the second viewpoint, inputting the reference image, and information of the second viewpoint to the NeRF to provide the second image corresponding to the 3D scene seen from the second viewpoint.

3. The method of claim 1, wherein the method further comprises:
receiving a fourth indication from the user, wherein the fourth indication is associated with a second object to be inpainted into the first image;
updating, before training the NeRF, the first image to remove the first object from the first image by using a mask, wherein the first image includes an unmasked portion and a masked portion; and
training the NeRF after the first object is removed from the first image, wherein the NeRF is trained to output an inpainted 3D scene from an unobserved view point by accepting as input a reference inpainted view image that is obtained by selecting one of a plurality of views of a scene and applying a mask to inpaint an object into the reference view image.

4. The method of claim 3, wherein the training is performed at the electronic device.

5. The method of claim 3, wherein the training is performed at a server.

6. The method of claim 1, further comprising:
receiving, after the displaying, a fifth indication from the user, wherein the fifth indication is a selection of a second object to be inpainted into the first image;
obtaining a second representative image by inpainting the second object into the first image;
updating the training of the NeRF based on the second representative image;
rendering, using the NeRF, a third image; and
displaying the third image on the display of the electronic device.

7. The method of claim 5, wherein the training the NeRF comprises training the NeRF, based on the reference image and the plurality of images, using a first loss associated with the unmasked portion.

8. The method of claim 7, wherein the training the NeRF further comprises training the NeRF using a second loss based on the masked portion and an estimated depth, wherein the estimated depth is associated with a first geometry of the first scene in the masked portion.

9. The method of claim 8, wherein the training the NeRF further comprises:
performing a view substitution of a target image to obtain a view substituted image, wherein the view substituted image comprises view dependent effects (VDEs) from a third viewpoint different from the first viewpoint associated with the first image, whereby view substituted colors are obtained associated with the third viewpoint, wherein a second geometry of the first scene underlying the view substituted image is that of the reference image, wherein the plurality of images comprises the target image and the target image is not the first image; and
training the NeRF using a third loss based on the view substituted colors.

10. The method of claim 9, wherein the training the NeRF further comprises:
identifying a plurality of disoccluded pixels, wherein the plurality of disoccluded pixels are present in the target image and are associated with the second viewpoint;
determining a fourth loss, wherein the fourth loss is associated with a second inpainting of the plurality of disoccluded pixels of the target image;
and
training the NeRF using the fourth loss.

11. The method of claim 1, further comprising, when the first object is removed from the reference image using a first mask, and if a second size of the first object in other images differs from a first size in the reference image, adjusting proportionally mask sizes of respective masks in the other images proportionally to the respective object sizes of the first object in the other images.

12. A method of training a neural radiance field, the method comprising:
initially training the neural radiance field using a first loss associated with a plurality of unmasked regions respectively associated with a reference image and a plurality of target images, wherein the reference image is associated with a reference viewpoint and each target of the plurality of target images is associated with a respective target viewpoint;
updating the training of the neural radiance field using a second loss associated with a depth estimate of a masked region in the reference image;
further updating the training of the neural radiance field using a third loss associated with a plurality of view-substituted images, wherein:
each view-substituted image of the plurality of view-substituted images is associated with the respective target view of the plurality of target images,
each view-substituted image is a volume rendering from the reference viewpoint across pixels with view-substituted target colors, and
the third loss is based on the plurality of view-substituted images.

13. The method of claim 12, further comprising additionally updating the training of the neural radiance field with a fourth loss, wherein the fourth loss is associated with dis-occluded pixels in each target image of the plurality of target images.

14. A method of rendering an image with depth information, the method comprising:
receiving image data that comprises a plurality of images that show a first scene from different viewpoints;
based on a first user input identifying a target object from one of the plurality of images, performing a first inpainting on the one of the plurality of images to obtain a reference image by applying a mask to the target object;
inpainting a 3D scene into a neural radiance field (NeRF), based on the reference image, by adjusting a first size of the mask according to a second size of the target object in each of remaining images other than the one of the plurality of images to obtain a plurality of adjusted masks, and applying the plurality of adjusted masks to respective ones of the remaining images; and
based on a second user input requesting a first image of the 3D scene seen from a requested view point, inputting the reference image, and the requested view point to a neural radiance field (NeRF) model to provide the first image, wherein the first image corresponds to the 3D scene seen from the requested view point.

15. An apparatus comprising:
one or more processors; and
one or more memories, the one or more memories storing instructions configured to cause the apparatus to at least:
receive a plurality of images from a user, wherein the plurality of images were acquired by the apparatus viewing a first scene and each of the plurality of images is associated with a corresponding viewpoint of the first scene;
receive a first indication identifying a first image of the plurality of images, wherein the first image is associated with a first viewpoint of the first scene;
receive a second indication of a first object to be removed from the first image;
remove the first object from the first image to obtain a reference image;
receive a third indication of a second viewpoint from the user, wherein the second viewpoint does not correspond to any of the plurality of images;
render, using a neural radiance field (NeRF), a second image that corresponds to a 3D scene as seen from the second viewpoint, wherein the 3D scene has been inpainted into the NeRF; and
display the second image on a display of the apparatus.

16. The apparatus of claim 15, wherein the instructions are further configured to cause the apparatus to remove the first object by performing a first inpainting on the first image by applying a mask to the first object, to obtain the reference image, and wherein the wherein the instructions are further configured to cause the apparatus to:
inpaint the 3D scene into the NeRF in part by adjusting a first size of the mask according to a second size of the first object that appears in the second image and applying the mask with the adjusted size to the second image; and
based on a user input requesting an image of the 3D scene seen from the second viewpoint, input the reference image, and information of the second viewpoint to the NeRF to provide the second image corresponding to the 3D scene seen from the second viewpoint.

17. The apparatus of claim 15, wherein the instructions are further configured to cause the apparatus to:
receive a fourth indication from the user, wherein the fourth indication is associated with a second object to be inpainted into the first image;
update, before a training of the NeRF, the first image to remove the first object from the first image by using a mask, wherein the first image includes an unmasked portion and a masked portion; and
train the NeRF after the first object is removed from the first image.

18. The apparatus of claim 17, wherein the apparatus is a mobile device.

19. The apparatus of claim 15, wherein the instructions are further configured to cause the apparatus to:
receive the NeRF from a server after a training of the NeRF, wherein the NeRF has been trained at the server.

20. A non-transitory computer readable medium storing instructions, the instructions configured to cause a computer to at least:
receive a plurality of images from a user, wherein the plurality of images were acquired by an electronic device viewing a first scene and each of the plurality of images is associated with a corresponding viewpoint of the first scene;
receive a first indication identifying a first image of the plurality of images, wherein the first image is associated with a first viewpoint of the first scene;
receive a second indication of a first object to be removed from the first image;
remove the first object from the first image to obtain a reference image;
receive a third indication of a second viewpoint from the user, wherein the second viewpoint does not correspond to any of the plurality of images;
render, using a neural radiance field (NeRF), a second image that corresponds to a 3D scene as seen from the second viewpoint, wherein the 3D scene has been inpainted into the NeRF; and
display the second image on a display of the electronic device.
